(19) United States
(12) Patent Application Publication
(10) Pub. No.: US 2026/0134671 A1
(43) Pub. Date: May 14, 2026

(54) 3D VEHICLE TARGET DETECTION METHOD FOR FUSING IMAGE TEXTURE FEATURES AND PRIOR INFORMATION

(71) Applicant: Chang'an University, Xi'an (CN)

(72) Inventors: Xin Cheng, Xi'an (CN); Jingmei Zhou, Xi'an (CN); Zhou Zhou, Xi'an (CN); Xuming Shang, Xi'an (CN); Shengxian Liu, Xi'an (CN); Licheng Zhang, Xi'an (CN); Ruru Hao, Xi'an, Shaanxi (CN); Zhaoxin Ma, Xi'an (CN)

(21) Appl. No.: 19/381,088

(22) Filed: Nov. 6, 2025

(30) Foreign Application Priority Data
Nov. 13, 2024 (CN) 202411616290.2

(51) Int. Cl. G06V 10/80; G06V 10/25; G06V 10/774; G06V 10/82; G06V 20/58; G06V 20/64

(52) U.S. Cl. CPC G06V 10/806; G06V 10/25; G06V 10/774; G06V 10/82; G06V 20/58; G06V 20/64; G06V 2201/07; G06V 2201/08

(57) ABSTRACT

The present disclosure provides a 3D vehicle target detection method for fusing image texture features and prior information. Through pixel-level fusion of point clouds and images, the method achieves high-precision and real-time three-dimensional vehicle detection in combination with decision-level fusion of a feature distance and channel attention, improves the detection stability in a complex environment, and is suitable for autonomous driving and intelligent transportation systems.

### CROSS-REFERENCE TO RELATED APPLICATION

This application claims priority of Chinese Patent Application No. 202411616290.2, filed on Nov. 13, 2024, the entire contents of which are incorporated herein by reference.

### TECHNICAL FIELD

The present disclosure relates to the technical field of three-dimensional vehicle target detection, and in particular, to a 3D vehicle target detection method for fusing image texture features and prior information.

### BACKGROUND

With the rapid development of autonomous driving and intelligent transportation systems, accurate and real-time three-dimensional vehicle target detection technologies are particularly important. Currently, common target detection methods mainly rely on the deep learning technology, perform detection based on 2D images, and then acquire three-dimensional information through post-processing steps. However, such methods usually handle the pose, angle, and occlusion of target objects inadequately. In addition, existing methods rarely make full use of the prior information of the vehicle and fuse the prior information and image texture features for detection, resulting in insufficient detection accuracy and robustness. Therefore, it is necessary to design a 3D vehicle target detection method for fusing image texture features and prior information.

### SUMMARY

In order to overcome the deficiencies of the existing technologies, the present disclosure aims to provide a 3D vehicle target detection method for fusing image texture features and prior information.

To achieve the above objective, the present disclosure provides the following solutions:

The present disclosure provides a 3D vehicle target detection method for fusing image texture features and prior information, which includes:
acquiring a data set and performing a pixel-level point cloud and image fusion based on point cloud data and image data in the data set;
detecting the image data based on a preset image target detector and generating an image 2D target box;
detecting the fused point cloud data based on a preset 3D vehicle target detection model and generating a point cloud 3D target box; and
fusing the image 2D target box and the point cloud 3D target box based on a decision-level fusion scheme of a feature distance and a channel attention to obtain a final 3D vehicle target detection result.

Preferably, the data set is a KITTI data set.

Preferably, performing a pixel-level point cloud and image fusion based on point cloud data and image data in the data set specifically includes:
acquiring image target prior information from a 2D target true box label file of the KITTI data set, acquiring a target category and a target box range in the image based on the image target prior information, after mapping the point cloud to the image, filtering out point clouds within the image target box according to the target box range, based on a Gaussian distance encoding category information assignment method, determining a probability of the point clouds within the viewing frustum belonging to a foreground target point through Gaussian distance feature information, assigning the probability to the point cloud data as a category score, and assigning pieces of target category information to these point clouds, and on this basis, assigning corresponding pixel R, G, B color values to each point cloud to generate point cloud data with rich feature information.

Preferably, detecting the image data based on a preset image target detector to generate an image 2D target box specifically includes:
constructing an image target detector based on a CascadeRCNN algorithm;
training the image target detector based on a preset training data set; and
inputting the image into the trained image target detector for detection to generate an image 2D target box.

Preferably, detecting the fused point cloud data based on a preset three-dimensional vehicle target detection model to generate a point cloud three-dimensional target box specifically includes:
constructing a 3D vehicle target detection model based on an improved PointPillars network model;
training the 3D vehicle target detection model based on the KITTI data set to obtain a trained 3D vehicle target detection model; and
inputting the fused point cloud data into the trained 3D vehicle target detection model to generate a point cloud 3D target box.

Preferably, constructing a three-dimensional vehicle target detection model based on the improved PointPillars network model specifically includes:
improving the PointPillars network model, adding a point cloud local attention mechanism module to a pillar feature net of a traditional PointPillars network model for capturing complex features within a specific area of the inputted point cloud, and integrating an SE attention mechanism module into a 2D pseudo-image network of the traditional PointPillars network model for enhancing the ability of the network to obtain global features and information; and
constructing a three-dimensional vehicle target detection model based on the improved PointPillars network model.

Preferably, fusing the image 2D target box and the point cloud 3D target box based on a decision-level fusion scheme of a feature distance and a channel attention to obtain a final 3D vehicle target detection result specifically includes:
encoding the image 2D target box and the point cloud 3D target box separately, and fusing a category confidence and a target box position to generate respective encoding tensors;
based on semantic consistency and geometric consistency, fusing the encoding tensors of the image 2D target box and the point cloud 3D target box to obtain a fused feature tensor;
inputting the fused feature tensor into a channel attention encoding-based convolutional neural network structure to finally obtain a fusion confidence score; and
redistributing the fusion confidence score to the point cloud 3D target box, and using a non-maximum suppression (NMS) algorithm to filter out redundant and falsely detected target boxes to generate the final 3D vehicle target detection result.

According to the specific embodiments provided by the present disclosure, the present disclosure discloses the following technical effects:

The present disclosure provides a 3D vehicle target detection method for fusing image texture features and prior information. The method includes acquiring a data set, performing a pixel-level point cloud and image fusion based on point cloud data and image data in the data set, detecting the image data based on a preset image target detector to generate an image 2D target box, detecting the fused point cloud data based on a preset three-dimensional vehicle target detection model to generate a point cloud three-dimensional target box, and fusing the image 2D target box and the point cloud three-dimensional target box based on a decision-level fusion scheme of a feature distance and a channel attention to obtain a final three-dimensional vehicle target detection result. By fusing the image texture features and the prior geometric information, the present disclosure significantly improves the accuracy and stability of three-dimensional vehicle detection, especially in complex environments. By adopting an efficient geometric optimization and depth information combination technology, the real-time performance of the system is ensured and the practical application needs of autonomous driving and intelligent transportation are met.

### BRIEF DESCRIPTION OF DRAWINGS

In order to more clearly illustrate the embodiments of the present disclosure or the technical solutions in the existing technologies, the following briefly introduces the accompanying drawings required for use in the embodiments. Apparently, the accompanying drawings described below are only some embodiments of the present disclosure. For those of ordinary skilled in the art, other drawings can be obtained based on these accompanying drawings without making any creative work.

FIG. 1 is a flow chart of a method provided by an embodiment of the present disclosure.

FIG. 2 is a schematic diagram of a KITTI lidar coordinate system and a camera coordinate system.

FIG. 3 is a fusion result diagram of point clouds and image data.

FIG. 4 is a point cloud image of a target viewing frustum of a vehicle;

FIG. 5 is a point cloud visualization scene diagram from a forward field of view (red represents the target point cloud).

FIG. 6 is an RGB information-fused point cloud visualization diagram based on a target box level.

FIG. 7 is an RGB information-fused point cloud visualization diagram based on a scene.

FIG. 8 is a schematic diagram of a PointPillars network algorithm framework.

FIG. 9 is a schematic diagram of an improved PointPillars network algorithm framework.

FIG. 10 is a geometric consistency relationship diagram under a same target.

FIG. 11 is a schematic diagram of a channel attention encoding-based convolutional network structure.

FIG. 12a is a visualization result diagram in partial scenes of other algorithms.

FIG. 12b is a visualization result diagram in partial scenes of this algorithm provided by the present disclosure.

### DETAILED DESCRIPTION OF EMBODIMENTS

The technical solutions in the embodiments of the present disclosure will be clearly and completely described below in conjunction with the accompanying drawings in the embodiments of the present disclosure. Apparently, the described embodiments are only part of the embodiments of the present disclosure, rather than all the embodiments. Based on the embodiments of the present disclosure, all other embodiments obtained by those of ordinary skill in the art without making any creative work shall fall within the scope of protection of the present disclosure.

An objective of the present disclosure is to provide a 3D vehicle target detection method for fusing image texture features and prior information, which can realize three-dimensional vehicle target detection based on the fusion of image texture features and prior information and is easy to use.

In order to make the above-mentioned objectives, features and advantages of the present disclosure more obvious and easier to understand, the present disclosure is further described in detail below with reference to the accompanying drawings and specific embodiments.

FIG. 1 is a flow chart of a method provided by an embodiment of the present disclosure. As shown in FIG. 1, the present disclosure provides a 3D vehicle target detection method for fusing image texture features and prior information, which includes the following:

At step 100, a data set is acquired, and a pixel-level point cloud and image fusion is performed based on point cloud data and image data in the data set.

At step 200, the image data is detected based on a preset image target detector and an image 2D target box is generated.

At step 300, the fused point cloud data is detected based on the preset 3D vehicle target detection model and a point cloud 3D target box is generated.

At step 400, the image 2D target box and the point cloud three-dimensional target box are fused based on a decision-level fusion scheme of a feature distance and a channel attention to obtain a final three-dimensional vehicle target detection result.

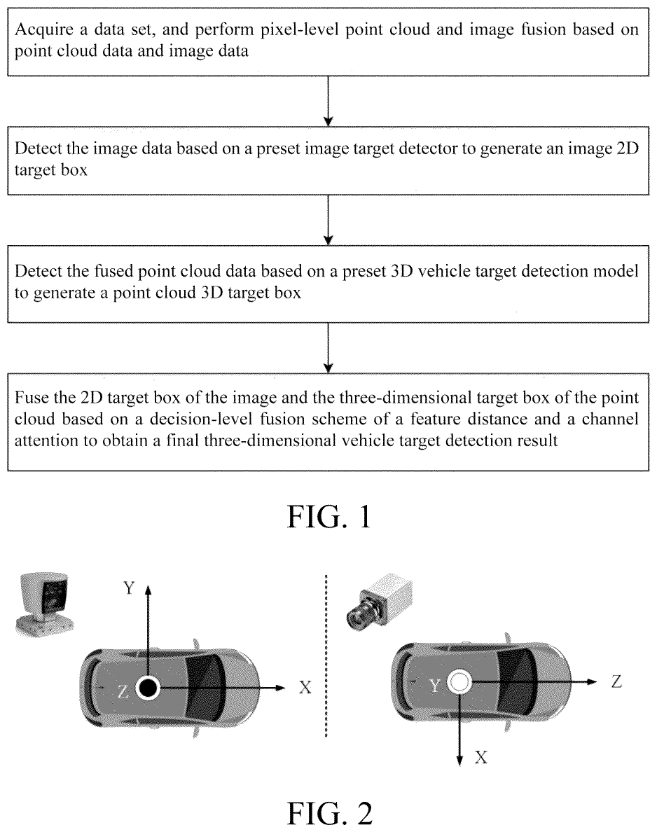

The data set is a KITTI data set. KITTI uses a vehicle-mounted lidar to collect the point cloud data and the image data. Since the collected image data does not have depth information, it is difficult to map the image to a point cloud scene using traditional methods. Regarding the fusion of the point cloud and the image data, most current methods map the point cloud to the image, reducing the dimensionality of the three-dimensional data to 2D data while retaining the depth information. In order to achieve coordinate transformation, the KITTI data set provides camera and lidar calibration parameters for each frame of data. According to the calibration parameters, the transformation matrix from the three-dimensional lidar coordinate system to the 2D image coordinate system can be calculated to achieve point cloud mapping. Since the lidar point cloud sampling range is wide and the field of view of the entire point cloud scene is 360°, considering the field of view of the camera sampling image and the point cloud distribution in the real traffic scene, the point clouds outside the image field of view are discarded during the point cloud projection process, and only the point clouds in the forward field of view are retained. FIG. 2 shows coordinate axis directions of the lidar coordinate system and the camera coordinate system in the KITTI data set, where the X axis of the lidar coordinate system represents forward, Y axis represents left, and Z axis represents upward; in the camera coordinate system, the X axis represents right, the Y axis represents downward, and the Z axis represents forward.

### (1) LiDAR Point Cloud Coordinates are Transformed to Camera Point Cloud Coordinates

The point cloud coordinates are transformed from the lidar coordinate system to the camera coordinate system, and a calibration extrinsic parameter matrix is required, namely the Tr_velo_to_cam transformation matrix, which contains a rotation matrix R and a translation matrix t. This matrix is a 3×4 matrix. After removing the reflection intensity from the inputted lidar point cloud coordinates, this matrix becomes an N×3 matrix containing the number of point clouds N and the original three-dimensional coordinate points in the lidar coordinate system. To ensure that the point cloud coordinates in the outputted camera coordinate system are also an N×3 matrix, the original point cloud needs to be dimensionally expanded, filled with a column of 1, and then transformed into an N×4 matrix. After multiplying this matrix with the transposed extrinsic parameter matrix, the point cloud coordinates in the camera coordinate system are obtained. Since the KITTI provides a total of four cameras, and the Tr_velo_to_cam matrix only transforms the lidar point cloud coordinates to the point cloud coordinates in the coordinate system of camera 0, to ensure that other cameras can use the transformed point cloud coordinates, this matrix needs to be multiplied by the correction rotation matrix R0_rect of the camera 0. The function of this matrix is to make the imaging of all cameras coplanar and ensure that the optical centers of the four cameras are on the same xoy plane. The overall calculation process is shown as follows:

$${[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{rect 0} = {{[ \begin{matrix}{x}_{1} & {y}_{1} & {z}_{1} & 1 \\ {x}_{2} & {y}_{2} & {z}_{2} & 1 \\ \cdot & \cdot & \cdot & \cdot \\ {x}_{n - 1} & {y}_{n - 1} & {y}_{n - 1} & 1 \\ {x}_{n} & {y}_{n} & {z}_{n} & 1\end{matrix} ]}_{Lidar} [ R \vert t ]}^{T}$$

$${[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{rect \_ R 0} = {{{[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{rect 0} [ R0\_rect ]}_{3 \times 3}}^{T} ;$$

where rect0 represents the uncorrected point cloud coordinate matrix in the camera coordinate system 0, Lidar represents the point cloud matrix in the radar coordinate system, R represents the rotation matrix with a size of 3×3, t represents the translation matrix with a size of 3×1, and rect R0 represents the corrected point cloud coordinate matrix in the camera coordinate system 0. During the calculation process, the [R|t] matrix and the R0_rect matrix need to be transposed.

### (2) Camera Point Cloud Coordinates are Transformed to Image Point Cloud Coordinates

To transform the point cloud coordinates from the camera coordinate system to the image coordinate system, the camera intrinsic calibration matrix, namely the Pᵢ matrix, is required. The Pᵢ matrix formula is shown below:

$${P}_{i}^{rect} = [ \begin{matrix}{f}_{u}^{i} & 0 & {c}_{u}^{i} & - {f}_{u}^{i} {b}_{x}^{i} \\ 0 & {f}_{v}^{i} & {c}_{v}^{i} & 0 \\ 0 & 0 & 1 & 0\end{matrix} ] ;$$

where fᵤ and fᵥ refer to a focal length of the camera, cu and c, refer to an offset from an optical center to a CMOS zero point, that is, the coordinates of the optical center of the camera in the image coordinate system, and bx refers to a distance offset from the current camera to the camera 0 in the x-axis direction.

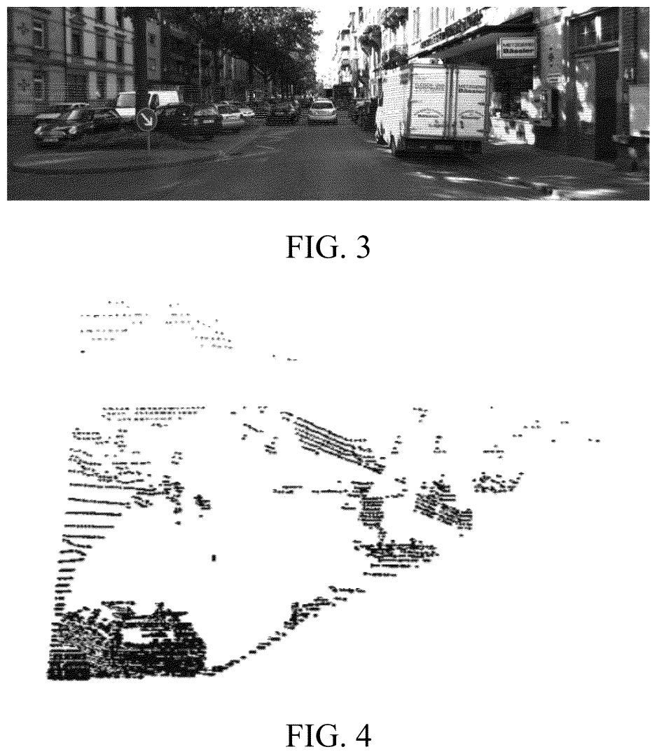

A color camera No. 2 is used as a transformation standard, the point cloud coordinates in the camera coordinate system obtained by calculation are multiplied by the intrinsic reference P2 of camera No. 2 to generate the point cloud coordinates in the image coordinate system. Since P2 is a 3×4 matrix, and the outputted point cloud coordinates in the camera coordinate system are an N×3 matrix, it is necessary to fill the point cloud coordinates with 1 in the columns to generate an N×4 matrix and multiply this matrix with the transposed matrix of P2 to obtain the point cloud coordinate result in the image coordinate system. To obtain homogeneous coordinates in the image coordinate system, it is necessary to normalize the point cloud coordinates in the z-axis depth direction. The point cloud coordinates in each image coordinate system is divided by the depth information to obtain the final coordinate result, as shown in the following formula:

$${[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{cam} = {{[ \begin{matrix}{x}_{1} & {y}_{1} & {z}_{1} & 1 \\ {x}_{2} & {y}_{2} & {z}_{2} & 1 \\ \cdot & \cdot & \cdot & \cdot \\ {x}_{n - 1} & {y}_{n - 1} & {y}_{n - 1} & 1 \\ {x}_{n} & {y}_{n} & {z}_{n} & 1\end{matrix} ]}_{rect \_ R 0} [ P 2 ]}^{T}$$

$${[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{cam / z} = {[ \begin{matrix}{x}_{1} & {y}_{1} & {z}_{1} \\ {x}_{2} & {y}_{2} & {z}_{2} \\ \cdot & \cdot & \cdot \\ {x}_{n - 1} & {y}_{n - 1} & {z}_{n - 1} \\ {x}_{n} & {y}_{n} & {z}_{n}\end{matrix} ]}_{cam} / [ \begin{matrix}{z}_{1} \\ {z}_{2} \\ \cdot \\ {z}_{n - 1} \\ {z}_{n}\end{matrix} ] ;$$

where cam represents the point cloud coordinate matrix in the image coordinate system, and cam/z represents the normalized point cloud matrix. An image depth map is generated according to the calculated point cloud coordinates in the image coordinate system. First, the point clouds that are not in the image view are filtered according to the length and width of the image. At the same time, since the z-axis represents the forward direction in the camera coordinate system, it is necessary to filter out the point clouds with z-axis depth values less than 0. These point clouds are not in the forward view. In order to make each point cloud a valid value and since the coordinates of each pixel in the image are integers, the point cloud coordinates need to be rounded to ensure that each point cloud can be correctly mapped to the image pixel. The calibration files provided by the KITTI are shown in Table 1, and the fusion diagram of the image and point cloud data is shown in FIG. 3.

TABLE 1
KITTI data set calibration file format example table

| Field name | Specific meaning |
|---|---|
| P0 | 0 is the camera number, representing the grayscale camera |
| | on the left, and P0 represents the intrinsic parameter matrix of the |
| | camera, with a size of 3 × 4 |
| P1 | 1 is the camera number, representing the grayscale camera |
| | on the right, and P1 represents the intrinsic parameter matrix of |
| | the camera, with a size of 3 × 4 |
| P2 | 2 is the camera number, representing the color camera on the |
| | left, and P2 represents the intrinsic parameter matrix of the |
| | camera, with a size of 3 × 4 |
| P3 | 3 is the camera number, representing the color camera on the |
| | right, and P3 represents the intrinsic parameter matrix of the |
| | camera, with a size of 3 × 4 |
| R0_rect | R0_rect represents the correction rotation matrix of the |
| | camera 0, with a size of 3 × 3. The purpose is to make imaging of |
| | the four cameras achieve a coplanar effect and ensure that the |
| | camera optical centers are on the same plane |
| Tr_velo_to_cam | Tr_velo_to_cam represents the rotation and translation |
| | matrix from the radar to the camera, including the rotation vector |
| | R and the translation vector t, with a size of 3 × 4 |
| Tr_imu_to_velo | Tr_imu_to_velo represents the rotation and translation |
| | matrix from the inertial navigation or GPS device to the radar. |
| | Similar to Tr_velo_to_cam, this parameter is negligible because |
| | the present disclosure does not use an inertial navigation device |

In step 100, performing a pixel-level point cloud and image fusion based on the point cloud data and image data in the data set specifically includes the following.

The image target prior information is acquired from the 2D target real box label file of the KITTI data set. A target category and a target box range in the image are acquired according to the image target prior information. After the point cloud is mapped to the image, the point cloud located in the image target box is filtered out according to the target box range. Based on a category information assignment method of Gaussian distance encoding, the probability of the point clouds in the viewing frustum belonging to the foreground target point is determined through Gaussian distance feature information. The probability is assigned to the point cloud data as the category score, and pieces of target category information is assigned to these point clouds. On this basis, the corresponding pixel R, G, B color values are assigned to each point cloud to generate point cloud data with rich feature information. The specific process is introduced below.

First, the pixel-level fusion based on target prior information and Gaussian coding is introduced first. PointPainting first uses a semantic segmentation network to perform semantic segmentation on the original image, obtain the category and category score of each pixel, and then map the point cloud to the image. The pixel category score is attached to the corresponding point cloud according to a corresponding relationship between the pixel and the mapped point cloud, to generate 8-dimensional point cloud data (x, y, z, r, s1, s2, s3, s4). The generated new point cloud data is putted into a 3D target detector for 3D target detection. Since this algorithm requires a high degree of coupling between the semantic segmentation model and the three-dimensional target detection model, the scope of application of the algorithm is limited. To address this problem, the present disclosure provides a point cloud and image fusion method based on image target prior information, which uses the prior results obtained from image target detection to expand the information of the original point cloud and generate point cloud data containing rich information. Since both 2D and 3D target detection are target detection tasks, which are combined in a loosely coupled manner. Furthermore, during the training process, the KITTI data set provides a 2D target ground truth box label file. Training data can be directly generated according to the image target prior information provided in this file. This eliminates the need to re-use the 2D detection model to perform target detection on the training images and then perform point cloud fusion after generating the results. This enhances the practicality of the algorithm and reduces the difficulty of data fusion.

The image target prior information provides the target category and target box range in the current image. After the point cloud is mapped to the image, the point cloud located within the image target box is filtered out according to the target box range, and these point clouds are assigned with pieces of target category information, which can provide more detailed information in the subsequent 3D target detection process. Since the point cloud data collected by the lidar is in a three-dimensional space, and the image data collected by the camera is in a 2D space, the depth information is lost when the point cloud is mapped to the image, which is equivalent to compressing the three-dimensional plane to a 2D plane. As a result, the point cloud within the filtered image target box is mapped back to the three-dimensional space and appears in the shape of a three-dimensional viewing frustum, as shown in FIG. 4. As can be seen from the figure, the point cloud within the viewing frustum can fully present the shape of the current target. However, due to the compression in the depth direction, a large number of background points are in the 2D target box. Therefore, assigning the same numerical category score to all point clouds in the viewing frustum will produce a large number of background noise point clouds. To address the above problems, this section designs a category information assignment method based on Gaussian distance encoding. The Gaussian distance feature information is used to determine the probability of the point clouds within the viewing frustum belonging to the foreground target point, and the probability is assigned to the point cloud data as a category score to enrich the original point cloud information.

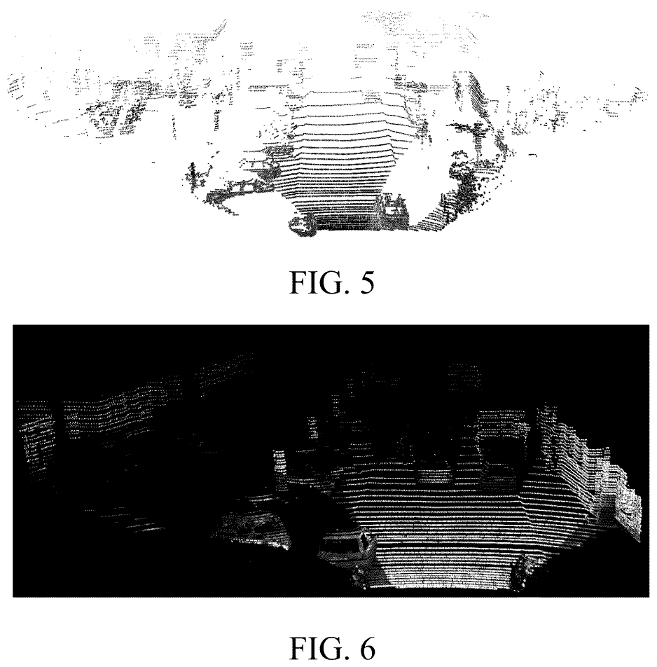

After observation, it is found that the coordinate center points of the 2D target box all are located on the detection target. The point clouds within a certain range of the center points are most likely the target point clouds. Therefore, the Gaussian distance is taken as a standard herein to measure the position distance between the point clouds in the target box and the center points of the 2D target box. The larger the Gaussian distance, the closer the point cloud is to the center of the target box on the 2D image, and the more likely it is the target point cloud. The smaller the distance, the farther the point cloud is from the center of the target box on the 2D image, and the more likely it is the background point cloud. A Gaussian distance calculation formula is shown as follows:

$$Gaussian\_distance ( x , y ) = {e}^{( - \frac{{( x - \overline{x} )}^{2}}{2 {w}^{2}} - \frac{{( y - \overline{y} )}^{2}}{2 {h}^{2}} )} ;$$

where (x,y) represent the point cloud coordinates mapped to the image target box, (x̅, y̅) are the center coordinates of the 2D target box, and w and h represent the width and height of the 2D target box respectively. The present disclosure only detects vehicle targets. Therefore, non-vehicle targets are regarded as background points in the process of generating category information. The calculated Gaussian distance information is assigned to the point clouds as the category information of the current target, and a total of 6-dimensional point cloud data (x, y, z, r, s1, s2) is generated, where s/represents the probability that the current point cloud is a vehicle target point cloud, and s2 represents the probability that the current point cloud is the background point cloud. The expanded point cloud data is mapped back to the three-dimensional space to obtain the visualization scene diagram shown in FIG. 5. For ease of observation, only the point cloud in the forward field of view is visualized. The red part in the figure represents the point cloud under the viewing frustum, that is, the point cloud data within the image target detection box, and the black part represents the background point cloud data.

Secondly, the pixel-level fusion based on image RGB texture features is introduced.

Image data, as 2D data containing rich texture and color information, is mainly represented by a 2D matrix composed of several pixels, and each pixel contains three color channels R, G, and B. As a data set containing several point clouds, the point cloud data only provides the three-dimensional coordinates x, y, z and a reflection intensity r of the original point cloud. In the 2D target detection task, RGB information provides sufficient image information for the convolutional neural network, ensuring the accuracy of target detection. Based on this, the present disclosure designs a fusion method based on the image RGB texture features on the basis of fusing the image target prior information. Each point cloud is assigned the corresponding R, G, B color values of the pixel point. At the same time, combined with the image target prior result information, it generates feature-rich point cloud data, including 9-dimensional data (x, y, z, r, s1, s2, R, G, B).

The present disclosure provides two strategies for fusing image RGB texture information and point clouds. Based on the different fusion areas, they are divided into target box-level RGB information fusion strategy (method 1) and scene-based RGB information fusion strategy (method 2):

Method 1: The RGB information is assigned to several target pyramidal point clouds obtained from the image target prior information, so that the subsequent 3D target detector can fully focus on the point clouds in the target area and achieve target classification and bounding box regression tasks, as shown in FIG. 6;

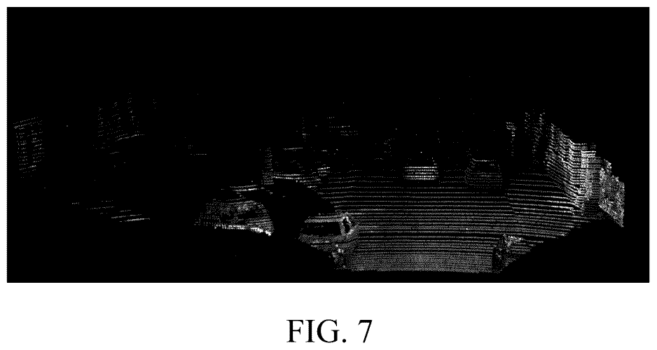

Method 2: RGB information is assigned to the point clouds from the perspective of the entire scene. All point clouds within the image viewing angle are assigned values to ensure that the point clouds have sufficient contextual structure. The subsequent 3D target detector can extract the entire scene during feature extraction, preventing the design of method 1 from losing some key point cloud information, as shown in FIG. 7.

In step 200, detecting the image data based on a preset image target detector to generate an image 2D target box specifically includes:
an image target detector is constructed based on a CascadeRCNN algorithm;
the image target detector is trained based on a preset training data set; and
the image is inputted into the trained image target detector for detection to generate an image 2D target box.

In step 300, detecting the fused point cloud data based on a preset 3D vehicle target detection model to generate a point cloud 3D target box specifically includes the following.

A 3D vehicle target detection model is constructed based on an improved PointPillars network model.

The 3D vehicle target detection model is trained based on the KITTI data set to obtain a trained 3D vehicle target detection model.

The fused point cloud data is inputted into the trained 3D vehicle target detection model to generate a point cloud 3D target box.

Constructing a 3D vehicle target detection model based on the improved PointPillars network model specifically includes the following.

The PointPillars network model is improved by adding a point cloud local attention mechanism module to a pillar feature net of the traditional PointPillars network model for capturing complex features within specific areas of the inputted point cloud; and an SE attention mechanism module is integrated into the 2D pseudo-image network of the traditional PointPillars network model for enhancing the ability of the network to obtain global features and information.

A 3D vehicle target detection model is constructed based on the improved PointPillars network model.

This process is introduced in detail below.

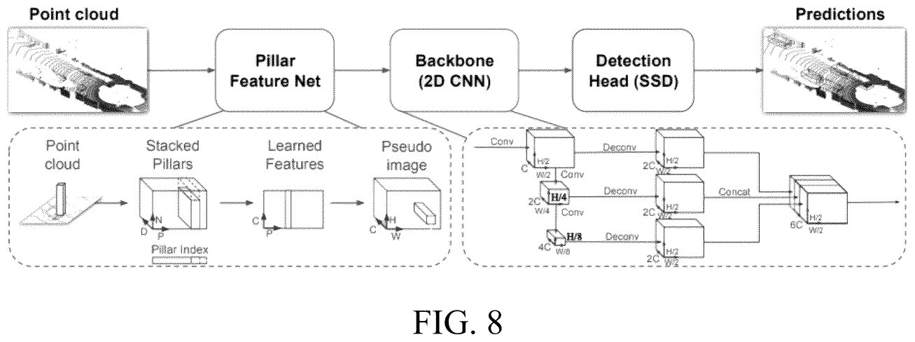

As shown in FIG. 8, the main components of the traditional PointPillars network model include a Pillar Feature Net, a Backbone network, and an SSD Detection Head. First, the point cloud data is preprocessed and feature-extracted, and then the data is projected into a bird's-eye view through a PFN module, and a feature representation of each voxel is generated. The PSE is used to encode the location information of voxels and improve the ability of the network to understand spatial structure. Next, the target proposal generator generates candidate target detection boxes according to the feature maps, and finally the target detection head predicts the existence, category, and location information of the target based on these boxes.

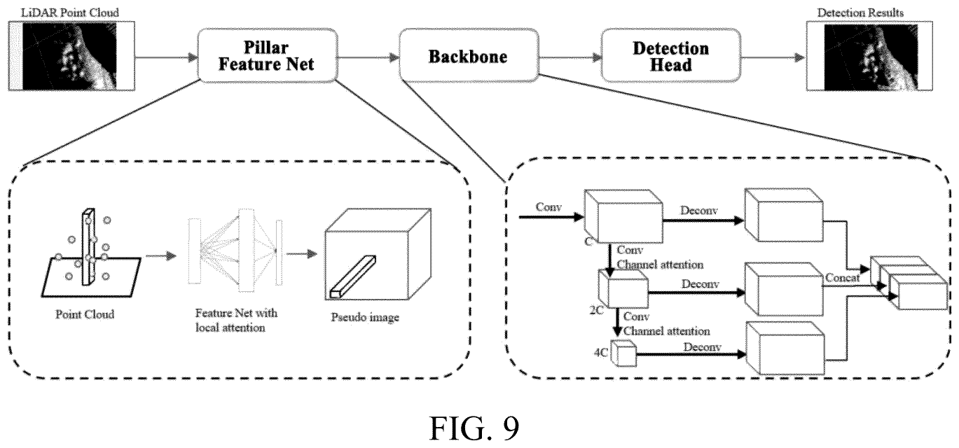

The present disclosure improves the traditional PointPillars network model as follows: First, a point cloud local attention mechanism network is added to the point cloud pillar feature extraction module to extract rich features from a single point cloud. This attention mechanism allows for a more comprehensive fusion of feature information from surrounding point clouds during the feature extraction stage. Second, a channel attention mechanism module is added to the 2D pseudo image backbone network. The final features are inputted into the SSD algorithm for target detection, and the overall network structure is shown in FIG. 9.

The main function of the point cloud local attention module is to enhance the representation ability of the point cloud data by introducing the attention mechanism. It enables the network to learn important information from the features of the point clouds while reducing the acquisition of irrelevant information. The inputted point cloud data is P, and each point cloud contains its own position coordinates (x, y, z). The point cloud under test undergoes a series of convolution operations to transform the inputted data into query, key, and a value tensor with different channel dimensions. Then the similarity between the query and the key is calculated, and the values are weighted and summed by means of the similarity to obtain the final output representation. The code divides the inputted data into local regions and adjusts the values of the query, key, and value tensor accordingly. An attention score is then calculated to determine the importance of elements within each local region. After further convolution and reshaping, the final output features are generated. This local attention module captures the local neighboring point information of a specific point cloud in the pillar and outputs the features of the key information of the local point cloud sampling points around the point cloud.

The present disclosure adopts the idea of SE attention mechanism and adds the channel attention mechanism module to the 2D pseudo image backbone network. Specifically, a BaseBackbone model class is defined in Pytorch and a channel attention mechanism sub-network is added. First, the input feature map is reduced in dimension. The global average pooling layer is used to reduce the input three-dimensional tensor (C, H, W) to (1, 1, C) so that the tensor can be regarded as a channel-dimensional descriptor. Next, two linear layers and an ReLU activation function are used to learn the nonlinear interactions between channels. Finally, the channel weight is mapped to between 0 and 1 through a Sigmoid activation function to form a channel attention weight.

The detection module uses single shot multiboxdetector (SSD) for target detection, which is a widely used single-stage detection algorithm known for its fast detection speed and high accuracy. In the SSD network, the concept of anchors is introduced to adapt to the multi-scale target detection task, making it more suitable for capturing large-scale transformations in the point cloud data. The SSD architecture consists of six main modules. The first module includes initial five layers (Conv1-Conv5) of a VGG16 convolutional network. Subsequently, the FC6 layer of VGG16 is merged in and the FC7 fully connected layer is converted into a Conv6 layer. The Conv7 layers form the second module. In order to extract target information at different scales, four additional modules, namely Conv8, Conv9, Conv10 and Conv11 convolutional layers, are introduced. The final stage involves target classification, detection, and non-maximum suppression of the regressed locations. Non-maximum suppression uses the 2D intersection over union (IoU) technique to match the prior bounding box with the actual target, ensuring that only the most relevant bounding boxes are retained and eliminating redundant detections.

Fusing the image 2D target box and the point cloud 3D target box based on a decision-level fusion scheme of a feature distance and a channel attention to obtain the final 3D vehicle target detection result specifically includes the following.

The image 2D target box and point cloud 3D target box are encoded separately, and the category confidence and the target box position are fused to generate respective encoding tensors.

Based on semantic consistency and geometric consistency, the encoding tensors of the image 2D target box and the point cloud 3D target box are fused to obtain a fused feature tensor.

The fused feature tensor is inputted into the channel attention encoding-based convolutional neural network structure to finally obtain a fusion confidence score.

The fusion confidence scores are reassigned to the point cloud3D target box, and the non-maximum suppression (NMS) algorithm is used to filter out redundant and falsely detected target boxes to generate a final 3D vehicle target detection result.

The above process is introduced in detail. First, a relationship between semantic consistency and geometric consistency is introduced as follows.

The decision-level fusion scheme independently detects the data collected by each sensor and fuses the detection results of all parts through the fusion module. In this fusion scheme, data from different sensors are processed independently, and the sensors do not interfere with each other. That is, when one of the sensors fails, the overall detection process is not affected, thereby improving the robustness of the detection. The scheme totally includes three modules in the process of point cloud and image fusion: an image target detection module, a point cloud target detection module, and a target box fusion module. The present disclosure uses a method that fuses image RGB texture features and image target prior information to generate a fused point cloud. An improved PointPillars network model is used to perform point cloud vehicle target detection on the fused point cloud. The existing CascadeRCNN algorithm is also used as an image target detector for image vehicle target detection. The two different detection results are fused at the decision level before the non-maximum suppression algorithm. To ensure the effectiveness of the fusion module and improve target detection accuracy, the present disclosure designs a fusion module based on a feature distance and a channel attention coding on the basis of a CLOCs algorithm.

The detection results obtained by different sensors are not correlated in terms of category confidence scores. From the perspective of geometric consistency and semantic consistency, the present disclosure encodes the image target detection results and the point cloud target detection results into a feature tensor with consistent correlation, performs feature extraction and pooling on the feature tensor, and remaps the generated probability scores back to the 3D target detection result.

### (1) Geometric Consistency

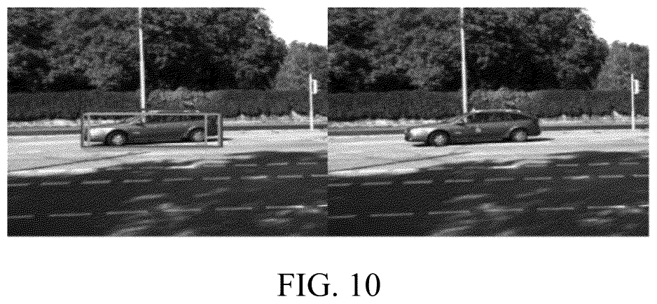

The 3D target detection result box is essentially a bounding box generated by drawing lines connecting 8 corner point data in the 3D scene. Therefore, similar to the point cloud data, the 8 corner point data of the 3D detection target result box can be projected onto a 2D plane, and the intersection over union (IoU) with the 2D target box can be calculated to quantify the geometric consistency of the two different detection result boxes. In addition, to address the problem that the CLOCs method only uses the IoU as a representation method to describe the geometric relationship between the 2D target box and the three-dimensional target box, and the representation relationship is relatively single, a method based on feature distance encoding is designed to expand the geometric consistency. As shown in FIG. 10, after the three-dimensional target box is projected onto the 2D plane, if the three-dimensional target box and the 2D target box in the image represent the same target, the two have a larger IoU ratio. Correspondingly, the feature distance between the center points of the two target box is small, indicating that the two target boxes belong to the same target. This section uses Euclidean distance as the feature distance to measure the center point of the target box. A calculation method is as follows:

$$dlc = \sqrt{{( {x}_{3 D} - {x}_{2 D} )}^{2} + {( {y}_{3 D} - {y}_{2 D} )}^{2}} ;$$

where (x_{3D}), y_{3D}) represents the coordinates of the center point of the three-dimensional target detection box, and (x_{2D}, y_{2D}) represents the coordinates of the center point of the 2D target detection box.

### (2) Semantic Consistency

In the target detection task, a frame of data may contain multiple targets, so the generated target detection result may include target detection boxes under multiple categories and corresponding category confidence scores. In order to achieve category confidence association of target detection results of different sensor data, only candidate detection is performed on target detection boxes of the same category to achieve semantic consistency association.

### Target Box Encoding Method

Before generating a fused feature tensor based on semantic consistency and geometric consistency, it is necessary to encode the image detection result box and the point cloud detection result box separately and fuse the category confidence and the target box position to generate respective encoding tensors.

The image target detection result box contains the coordinate points of the 2D target box and the category confidence scores. All detection results of the same category in a frame of data are encoded. The present disclosure only focuses on vehicle targets. Assuming that there are m 2D vehicle target detection result boxes, the encoding process is shown as follows:

$${P}^{2 D} = \{ {p}_{1}^{2 D} , {p}_{2}^{2 D} , {p}_{3}^{2 D} , … , {p}_{m}^{2 D} \}$$

$${p}_{i}^{2 D} = \{ [ {x}_{i 1}^{2 D} , {y}_{i 1}^{2 D} , {x}_{i 2}^{2 D} , {y}_{i 2}^{2 D} ] , {s}_{i}^{2 D} \} ;$$

where P^{2D} represents an encoding result set of m target detection result boxes in a frame of image data, Pᵢ^{2D} is the i^{th} image target detection result box, sᵢ^{2D} represents the category confidence score of the i^{th} result box, (xᵢ₁^{2D}, yᵢ₁^{2D}) and (xᵢ₂^{2D}, yᵢ₂^{2D}) represent the coordinate values of the upper left corner and lower right corner of the 2D target box respectively.

The point cloud target detection result box contains the center point coordinates of the 3D target box, the size of the 3D target box, and the category confidence score. Assuming that a frame of point cloud data contains n vehicle target detection result boxes, the same encoding method as the image target box is used. The encoding process is shown as follows:

$${P}^{3 D} = \{ {p}_{1}^{3 D} , {p}_{2}^{3 D} , {p}_{3}^{3 D} , … , {p}_{n}^{3 D} \}$$

$${p}_{i}^{3 D} = \{ [ {x}_{i} , {y}_{i} , {z}_{i} , {h}_{i} , {l}_{i} , {w}_{i} , {θ}_{i} ] , {s}_{i}^{3 D} \} ;$$

where P^{3D} represents an encoding result set of n target detection boxes in a frame of the point cloud data, P^{3D} is the i^{th} point cloud target detection result box, (xᵢ, yᵢ, xᵢ, hᵢ, wᵢ, lᵢ, θᵢ) represent the center point coordinates, height, width, length and orientation angle of the three-dimensional target detection box respectively, and sᵢ^{3D} represents the category confidence score of the i^{th} target detection box.

Based on the encoding results of the integrated image target box and the point cloud target box, for a frame of data with m 2D detection result boxes and n 3D detection result boxes, a fusion tensor T with a size of m×n×4 is constructed, as shown in the following formula:

$${T}_{i , j} = \{ {IoU}_{i , j} , {s}_{i}^{2 D} , {s}_{j}^{3 D} , {d}_{j} \} ;$$

where T_{i,j} represents a fusion tensor generated by the i^{th} 2D target result box and the j^{th} 3D target result box, IoU_{i,j} represents an IoU ratio of the j^{th} 3D target result box and the i^{th} 2D target box after being projected onto the image, sᵢ^{2D} and sᵢ^{3D} are the category confidence scores of the i^{th} 2D target result box and the j^{th} 3D target result box, respectively, and di represents a normalized distance from the j^{th} 3D target result box to a lidar plane.

Moreover, according to the encoding results of the image target box and the point cloud target box, a center point feature distance is calculated to construct a feature distance tensor with a size of m×n×1, as shown in the following formula:

$${D}_{i , j} = \{ {dlc}_{i , j} \} ;$$

where dlc_{i,j} represents the Euclidean distance between the center point of the i^{th} 2D target box and the center point of the j^{th} three-dimensional target box.

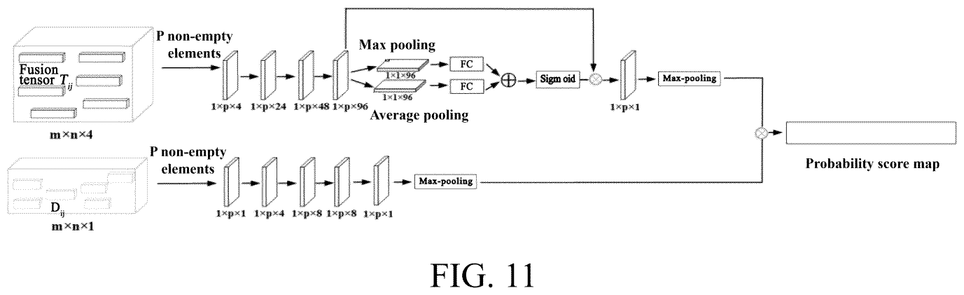

CLOCs has designed a convolutional neural network based on a fully connected structure. By inputting the fused target box encoding tensor into the network, it performs feature dimensionality upgrade and maximum pooling to generate a new probability score map. However, since the network only extracts features on the same target pair (an element in the fusion tensor set) during the feature dimensionality increase process, the association between different target pairs is ignored, resulting in the importance of different features being neglected. To address the above problems, the present disclosure designs a channel attention encoding-based convolutional neural network structure, which adopts a 1×1 2D convolution kernel for feature dimensionality upgrade, and introduces channel attention to enhance the correlation between different target pairs. The network structure is shown in FIG. 11.

There are a large number of empty elements in the generated fusion tensor T_{i,j} and feature distance tensor D_{i,j}. This is because the number of 2D target detection boxes is much smaller than that of three-dimensional target detection boxes and the fusion tensor and feature tensor can only be constructed when two target detection boxes have an intersection. Therefore, before feature extraction, it is necessary to find the non-empty elements p of the two tensors and perform convolution operations on the non-empty elements p to reduce computing memory and improve computing efficiency.

For the fusion tensor T_{i,j}, the 4-layer convolutional neural network shown in Table 2 is first used to expand the feature vector to 96 dimensions. After convolution of each layer, the ReLU activation function is used to filter out the feature values less than or equal to 0, thereby ensuring that the generated fusion confidence scores are all greater than 0. To strengthen the association between different target pairs, a channel attention module is introduced. Maximum pooling and average pooling are performed on the non-empty element dimension respectively to obtain the association scores of different target pairs, which are multiplied with the fusion tensor after dimension increase to generate a fusion tensor with rich semantic information. The maximum pooling method is used to obtain the probability distribution map based on the fusion vector. For the feature distance tensor D_{i,j}, a small 4-layer convolutional neural network and maximum pooling as shown in Table 3 are used to obtain a feature distance weight score. The final fusion confidence score is obtained by multiplying and correcting the feature distance weight score with the probability distribution map obtained by the fusion tensor branch. The fused confidence scores are redistributed to the 3D detection targets, and the NMS algorithm is used to filter out redundant and falsely detected target boxes to generate a final 3D vehicle target detection result.

TABLE 2
Structural table of fused tensor branch convolutional network

| | | | Network parameter | | |
|---|---|---|---|---|---|
| | | | Convolution | Convolution | Step |
| Number | Input size | Output size | type | kernel size | length |
| 1 | 1 × p × 4 | 1 × p × 24 | 2D | 1 × 1 | 1 |
| | | | convolution | | |
| 2 | 1 × p × 24 | 1 × p × 48 | 2D | 1 × 1 | 1 |
| | | | convolution | | |
| 3 | 1 × p × 48 | 1 × p × 96 | 2D | 1 × 1 | 1 |
| | | | convolution | | |
| 4 | 1 × p × 96 | 1 × p × 1 | 2D | 1 × 1 | 1 |
| | | | convolution | | |

TABLE 3
Structural table of feature distance
tensor branch convolutional network

| | | | Network parameter | | |
|---|---|---|---|---|---|
| | | | Convolution | Convolution | Step |
| Number | Input size | Output size | type | kernel size | length |
| 1 | 1 × p × 1 | 1 × p × 4 | 2D | 1 × 1 | 1 |
| | | | convolution | | |
| 2 | 1 × p × 4 | 1 × p × 8 | 2D | 1 × 1 | 1 |
| | | | convolution | | |
| 3 | 1 × p × 8 | 1 × p × 8 | 2D | 1 × 1 | 1 |
| | | | convolution | | |
| 4 | 1 × p × 8 | 1 × p × 1 | 2D | 1 × 1 | 1 |
| | | | convolution | | |

The present disclosure uses a Focal Loss function as a loss function of the decision-level fusion module to solve the problem of imbalance between foreground and background, as shown in the following formula:

$${L}_{total} = \frac{1}{{N}_{pos}} {\sum }_{i}^{Na} {L}_{cls} ( {p}_{i} , {c}_{i} )$$

$${L}_{cls} ( {p}_{i} , {t}_{i} ) = \{ \begin{matrix}- {α ( 1 - {p}_{i} )}^{γ} log ( {p}_{i} ) , & {c}_{i} = 1 \\ - ( 1 - α ) {{p}_{i}}^{γ} log ( 1 - {p}_{i} ) , & {c}_{i} = 0\end{matrix} ;$$

where Lₜₒₜₐₗ represents a total loss value, Nₚₒₛ represents the number of positive samples, and Nₐ represents the total number of generated three-dimensional target boxes; cᵢ represents a true value of the i^{th} target box, cᵢ=1 represents a vehicle target, and cᵢ=0 represents a background target; pᵢ is a category confidence prediction value of the i^{th} 3D detection box. γ is a hard-easy sample factor hyperparameter, which aims to enhance the learning of the model on difficult samples; a is a balancing factor hyperparameter, which aims to adjust the ratio of positive and negative samples. In the present disclosure, α=0.25 and γ=2.

The experimental results of the present disclosure are analyzed as follows:

### (1) Performance Comparison Between 3D Target Detector Based on Point Cloud and Image Fusion and 3D Target Detector Based on Single Point Cloud

The present disclosure uses two average detection precision indicators, AP_{3D_}R11 and AP_{3D_}R40, to evaluate the performance of the proposed multimodal fusion algorithm on the KITTI 3D target data set. When the R11 method is used to calculate the average detection precision, the proposed method achieves 3D vehicle target detection accuracies AP_{3D} of 90.35%, 80.39%, and 78.43% at the easy, medium, and hard difficulty levels, respectively. When the R40 method is used to calculate the average detection accuracy, the proposed method achieves three-dimensional vehicle target detection accuracy AP_{3D} of 92.94%, 82.70%, and 78.21% at the three difficulty levels of easy, medium, and difficult, respectively. This proves that the target detection algorithm based on point cloud and image fusion proposed in the present disclosure can effectively achieve three-dimensional vehicle target detection. In order to reduce the time overhead of adding image information to the pixel-level fusion method and the decision-level fusion method, it is verified that the three-dimensional target detector based on the fusion of point cloud and image has certain advantages over the three-dimensional target detector based on the single point cloud.

### (2) Comparison of Two Image RGB Information Fusion Methods

Table 4 shows the comparison results of detection accuracy of two different image RGB information fusion methods. Method 1 is based on the fusion of image RGB texture information at the target box level. The target point cloud is filtered according to the prior 2D target box to generate a point cloud frustum. The RGB information is only fused for the target point cloud viewing frustum within the scene to ensure that the algorithm fully focuses on the target point cloud during the feature extraction process. Method 2 is based on the fusion of scene-based image RGB texture information, which performs RGB information fusion on the point cloud scene under the forward field of view of the entire image to ensure that the point cloud information has sufficient context structure and prevent the loss of key point cloud information. Experimental results show that the method based on the fusion of the image RGB information of the entire scene (method 2) can provide more point cloud information and scene structure information for the 3D target detector. During the feature extraction process, the algorithm can extract more complete and richer high-dimensional semantic features of the point cloud. Therefore, the average detection accuracy AP_{3D} of method 2 is slightly higher than that of method 1, and it has the best performance.

TABLE 4
Comparison on average detection accuracies
of two image RGB information fusion methods

| Fusion | AP_{3D —}R11 (%) | | | AP_{3D —}R40 (%) | | |
|---|---|---|---|---|---|---|
| method | Easy | Medium | Difficult | Easy | Medium | Difficult |
| Method 1 | 89.23 | 79.35 | 77.61 | 92.58 | 81.11 | 77.57 |
| Method 2 | 90.35 | 80.39 | 78.43 | 92.94 | 82.70 | 78.21 |

### (3) Table of Comparison Between the Method of the Present Disclosure and Other Methods

The average detection accuracy AP_{3D} of the proposed fusion method is compared with other 3D target detection methods, as shown in Table 5. The 11 interpolation points (R11) method is used for measurement. The accuracies of other 3D target detection methods are all from respective literature.

TABLE 5
Comparison on the average detection accuracy of the proposed method
and other methods on the KITTI 3D target validation set

| | | AP_{3D —}R11 (%) | | | AP_{BEV —}R11 (%) | | |
|---|---|---|---|---|---|---|---|
| Method | Data source | Easy | Medium | Difficult | Easy | Medium | Difficult |
| Part-A2 | Lidar | 89.47 | 79.49 | 78.24 | 90.42 | 81.11 | 77.57 |
| SECOND-l | Lidar | 88.89 | 78.74 | 78.74 | 90.34 | 82.70 | 78.21 |
| IA-SSD | Lidar | 88.34 | 79.57 | 79.57 | — | — | — |
| MV3D | Lidar | 71.29 | 62.68 | 62.68 | 86.55 | 78.10 | 76.67 |
| F-PointNet | Lidar | 83.76 | 70.92 | 70.92 | 88.16 | 84.02 | 76.44 |
| ContFusion | Lidar | 86.32 | 73.25 | 73.25 | 95.44 | 87.34 | 82.43 |
| PointPainting | Lidar | 88.38 | 77.74 | 77.74 | 89.45 | 88.11 | 83.36 |
| MANet | Lidar | 88.76 | 77.63 | 77.63 | — | — | — |
| UberATG-MMF | Lidar | 88.40 | 77.43 | 77.43 | — | — | — |
| The method of | Lidar | 90.35 | 80.39 | 80.39 | 91.42 | 89.54 | 87.63 |
| the present | | | | | | | |
| disclosure | | | | | | | |

As shown in Table 5, compared with three-dimensional target detection methods based solely on lidar po nd difficult samples. For example, on easy samples, this method achieves improvements in average detection precision AP_{3D} of 0.88%, 1.46%, and 2.01%, respectively. Compared with multimodal feature fusion methods based on view projection such as MV3D, this method achieves leading vehicle target detection performance; the detection results of the multimodal fusion method proposed in the present disclosure are also better than other multimodal fusion methods such as FPointNet, ContFusion, PointPainting, MANet, and UberATG-MMF. The average detection accuracy AP_{3D} on medium-difficulty samples is improved by 9.47%, int clouds, such as Part-A2, SECOND-L, and IA-SSD, the method of the present disclosure achieves superior vehicle target detection results on easy, medium, a 7.14%, 2.65%, 2.76%, and 2.96%, respectively.

### (4) Qualitative Analysis of Target Detection Performance

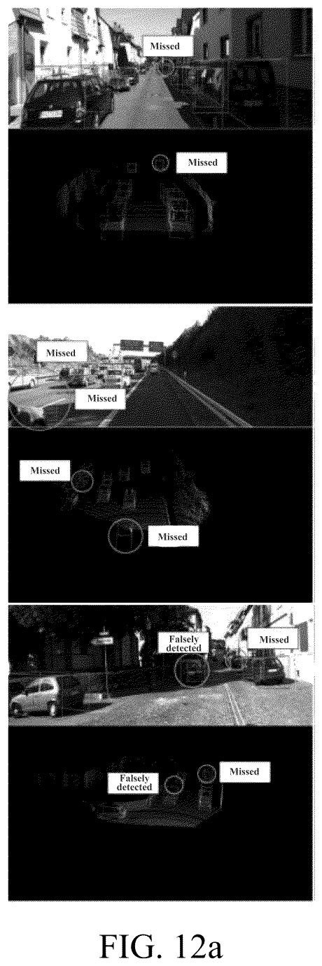

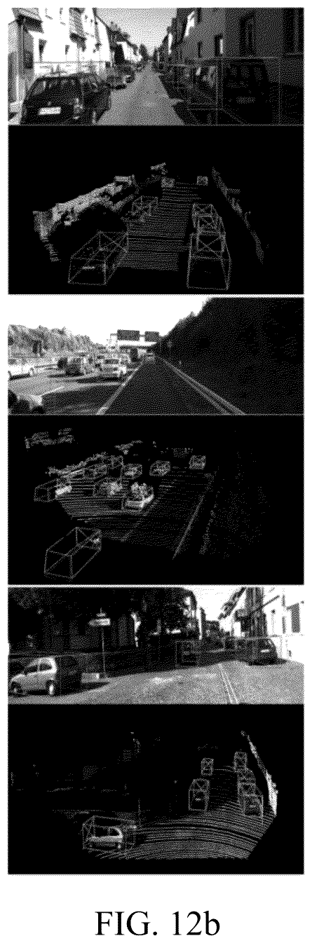

Tools such as Open3D and OpenCV are used to draw an original point cloud, a 3D target detection result, an original image and image detection results. The visualization results are shown in FIG. 12. In the 3D scene, the green 3D target box represents a 3D real vehicle target box, the red 3D target box represents a vehicle target prediction box of the method of the present disclosure, the blue 3D target box represents a vehicle target prediction box of other methods, and the white one represents the original point cloud; in the 2D image, the green three-dimensional target box represents the real vehicle target box, the red three-dimensional target box represents the vehicle target prediction box of the method of the present disclosure, and the blue three-dimensional target box represents the vehicle target prediction box of other methods. In both visualization results, orange circles indicate missed targets, and pink circles indicate falsely detected targets.

It can be seen from the visualization result diagram that when other algorithms are used to detect vehicle targets on lidar point clouds, the algorithm can better locate vehicle targets in different postures and at different truncation degrees. However, since this method is only based on point cloud detection, the single point cloud data collected by the lidar sensor does not contain sufficient information, resulting in missed detections and false detections in some traffic scenes, as shown in FIG. 12a, marked with orange and pink circles respectively. Compared with the detection method based only on point cloud, the present disclosure integrates the image information branch, adds the pixel-level fusion method in the data processing stage, and adds the decision-level fusion method before non-maximum suppression, which greatly improves the detection performance. As can be seen from FIG. 12b, compared with the point cloud 3D target detection method without fusion of image information, the algorithm of the present disclosure compensates for the problem of insufficient semantic information contained in the point cloud data collected by the single lidar sensor to a certain extent after fusing the image information branch. In the process of 3D vehicle target detection feature extraction, the algorithm can extract denser and richer semantic features from the multimodal fusion point cloud, effectively improving the 3D vehicle target detection accuracy and enhancing the detection performance of the above-mentioned missed and falsely detected targets. Moreover, effective detection can be achieved for vehicle targets with different degrees of occlusion, different postures, and sparse point clouds.

The present disclosure also evaluates the pixel-level fusion method based on image RGB texture features and image target prior results.

By applying the fusion scheme to different existing 3D target detectors for comparative experiments, the R11 method is used to measure the average detection accuracy. The results are shown in Table 6. Experimental results show that the proposed method significantly improves the detection performance of different 3D target detectors. A comprehensive comparison shows that the proposed fusion scheme has the best effect on improving the PointRCNN 3D target detection algorithm based on raw point clouds, with improvements of 0.94%, 1.03%, and 1.12% compared to the original PointRCNN method for easy, medium, and difficult samples, respectively. Since the pixel-level fusion method in the present disclosure directly expands the dimension and enriches the information at the level of the original point cloud data, the feature extraction network based on the original point cloud can directly obtain better semantic features and achieve high-precision detection. The above results show that the pixel-level fusion method proposed in the present disclosure can effectively enhance point cloud information and improve target detection accuracy.

TABLE 6
Comparison on average detection accuracy of the pixel-level fusion
scheme of the present disclosure on different 3D detectors

| | Data | AP_{3D —}R11 (%) | | | AP_{BEV —}R11 (%) | | |
|---|---|---|---|---|---|---|---|
| Method | source | Easy | Medium | Difficult | Easy | Medium | Difficult |
| PointPillars | Lidar | 84.45 | 76.18 | 72.17 | 89.83 | 86.99 | 83.61 |
| The fusion | Lidar | 85.07 | 77.29 | 76.89 | 89.95 | 87.74 | 87.44 |
| method of the | | | | | | | |
| present | | | | | | | |
| disclosure + | | | | | | | |
| PointPillars | | | | | | | |
| Lifting | — | 0.62 | 1.11 | 4.72 | 0.12 | 0.75 | 3.83 |
| PointRCNN | Lidar | 87.93 | 77.98 | 76.03 | 89.61 | 87.89 | 85.87 |
| The fusion | Lidar | 89.58 | 79.99 | 79.69 | 90.44 | 89.46 | 88.93 |
| method of the | | | | | | | |
| present | | | | | | | |
| disclosure + | | | | | | | |
| PointRCNN | | | | | | | |
| Lifting | — | 1.65 | 2.01 | 3.66 | 0.83 | 1.57 | 3.06 |
| Second | Lidar | 87.43 | 76.71 | 69.27 | 89.79 | 87.07 | 79.66 |
| The fusion | Lidar | 88.80 | 79.14 | 78.36 | 90.03 | 89.23 | 88.67 |
| method of the | | | | | | | |
| present | | | | | | | |
| disclosure + | | | | | | | |
| SECOND | | | | | | | |
| Lifting | — | 1.37 | 2.43 | 9.09 | 0.24 | 2.16 | 9.01 |

The present disclosure also evaluates the decision-level fusion method based on channel attention and feature distance. The decision-level fusion module proposed in the present disclosure can also be regarded as an independent module, which realizes target box fusion by analyzing the geometric consistency and semantic consistency of the detection results of different sensors. The present disclosure analyzes the experimental results from two aspects: ablation experiments and performance comparison on different three-dimensional target detectors. The image 2D target detectors used in the experiments are all Cascade-RCNN.

### (1) Ablation Experiment

The present disclosure introduces channel attention encoding and feature distance encoding based on the CLOCs method, improving the problems existing in the CLOCs method. To verify the effectiveness of the introduced module, an ablation comparison experiment as shown in Table 7 is conducted. The measurements are performed using the R11 and R40 methods. When the channel attention module and feature distance module are not added, the fusion module degenerates into the CLOCs method; when the channel attention module is added, different target pairs between the fused tensors generated by the two target detection result boxes interact in the convolutional network, generating more reliable category confidence scores. Under the R11 method measurement, AP_{3D} is improved by 0.12%, 0.03%, and 0.06% on easy, medium, and difficult samples, respectively. The feature distance module improves the single method of quantifying geometric consistency in the CLOCs method and enhances the geometric consistency relationship between the detection results of different sensors. When measured by the R11 method, AP_{3D} is improved by 0.21%, 0.07%, and 0.02% on simple, medium, and difficult samples, respectively. By simultaneously introducing channel attention and feature distance into the fusion module, when using the R11 metric, compared with the original CLOCs method, the AP_{3D} is improved by 0.71%, 0.44%, and 0.36% on easy, medium, and difficult samples, respectively. The above results show that the method proposed in the present disclosure can effectively improve the problems existing in the CLOCs method.

TABLE 7
Experimental table for verifying the effectiveness
of channel attention and feature distance encoding

| Channel | Feature | AP_{3D —}R11 (%) | | | | | |
|---|---|---|---|---|---|---|---|
| atten- | dis- | | | Diffi- | AP_{3D —}R40 (%) | | |
| tion | tance | Easy | Medium | cult | Easy | Medium | Difficult |
| — | — | 89.20 | 79.32 | 77.65 | 92.47 | 81.11 | 77.75 |
| ✓ | — | 89.32 | 79.35 | 77.71 | 95.58 | 81.31 | 77.57 |
| — | ✓ | 89.41 | 79.39 | 77.67 | 92.61 | 81.33 | 77.80 |
| ✓ | ✓ | 89.91 | 79.76 | 78.01 | 92.83 | 81.50 | 78.09 |

### (2) Comparison on Decision-Level Fusion Results on Different 3D Target Detectors

This experiment adds decision-level fusion to various 3D target detectors for experimental comparison, all of which are measured using R11. It can be known from the results in Table 8 that the detection accuracy of different 3D target detectors is improved when the decision-level fusion method proposed in the present disclosure is added. For methods with lower baseline accuracy, such as the SECOND and PointPillars algorithms, the decision-level fusion solution significantly improves vehicle target detection accuracy. Using the R11 metric, for the SECOND algorithm, this scheme improves the average detection accuracy AP_{3D} by 6.08% at difficult detection levels. For the PointPillars algorithm, the average detection precision AP3D improved by 3.87%, 2.02%, and 3.19% on easy, medium, and difficult samples, respectively. For methods with higher baseline accuracy, such as the PointRCNN algorithm and the PV-RCNN algorithm, the decision-level fusion scheme has a certain effect on improving detection accuracy. Using the R11 metric, for the PointRCNN algorithm and the PV-RCNN algorithm, this decision-level fusion scheme has achieved an average detection precision AP_{3D} improvement of 1.41% and 1.58%, respectively, on medium samples. The above results show that the decision-level fusion scheme proposed in the present disclosure has a good effect on improving the detection performance of the three-dimensional target detection method based on a single point cloud.

TABLE 8
Comparison on the average detection accuracy of
the decision-level fusion scheme in the present
disclosure on different 3D target detectors

| | R11_AP_{3D} (%) | | | | | |
|---|---|---|---|---|---|---|
| | | | Diffi- | R11_AP_{BEV} (%) | | |
| Method | Easy | Medium | cult | Easy | Medium | Difficult |
| SECOND | 87.43 | 76.71 | 69.27 | 89.79 | 87.07 | 79.66 |
| The fusion method | 88.03 | 78.02 | 75.35 | 89.89 | 88.03 | 86.28 |
| of the present | | | | | | |
| disclosure + | | | | | | |
| SECOND | | | | | | |
| Lifting | 0.6 | 1.31 | 6.08 | 0.1 | 0.96 | 6.62 |
| PointPillars | 84.45 | 76.18 | 72.17 | 89.83 | 86.99 | 83.61 |
| The fusion method | 88.32 | 78.20 | 75.36 | 89.91 | 88.15 | 86.29 |
| of the present | | | | | | |
| disclosure + | | | | | | |
| PointPillars | | | | | | |
| Lifting | 3.87 | 2.02 | 3.19 | 0.08 | 1.16 | 2.68 |
| PointRCNN | 87.93 | 77.98 | 76.03 | 89.61 | 87.89 | 85.87 |
| The fusion method | 89.35 | 79.39 | 77.43 | 90.42 | 89.54 | 86.63 |
| of the present | | | | | | |
| disclosure + | | | | | | |
| PointRCNN | | | | | | |
| Lifting | 1.42 | 1.41 | 1.4 | 0.81 | 1.65 | 0.76 |
| PV-RCNN | 92.10 | 84.36 | 82.48 | 93.02 | 90.33 | 88.53 |
| The fusion method | 92.78 | 85.94 | 83.25 | 93.48 | 91.98 | 89.48 |
| of the present | | | | | | |
| disclosure + PV- | | | | | | |
| RCNN | | | | | | |
| Lifting | 0.68 | 1.58 | 0.77 | 0.46 | 1.65 | 0.95 |

The various embodiments in this Specification are described in a progressive manner, and each embodiment focuses on the differences from other embodiments. The same or similar parts between the various embodiments can be referenced to each other.

1. A 3D vehicle target detection method for fusing image texture features and prior information, comprising:
acquiring a data set and performing a pixel-level point cloud and image fusion based on point cloud data and image data in the data set, specifically comprising:
the data set being a KITTI data set, acquiring image target prior information from a 2D target true box label file of the KITTI data set, acquiring a target category and a target box range in the image based on the image target prior information, after mapping the point cloud to the image, filtering out point clouds within the image target box according to the target box range, based on a Gaussian distance encoding category information assignment method, determining a probability of the point clouds within viewing frustum belonging to a foreground target point through Gaussian distance feature information, assigning the probability to the point cloud data as a category score, and assigning pieces of target category information to these point clouds, and on this basis, assigning corresponding pixel R, G, B color values to each point cloud to generate point cloud data with rich feature information;
detecting the image data based on a preset image target detector and generating an image 2D target box:
detecting the fused point cloud data based on a preset 3D vehicle target detection model and generating a point cloud 3D target box; and
fusing the image 2D target box and the point cloud 3D target box based on a decision-level fusion scheme of a feature distance and a channel attention to obtain a final 3D vehicle target detection result, specifically comprising:
encoding the image 2D target box and the point cloud 3D target box separately, and fusing a category confidence and a target box position to generate respective encoding tensors;
based on semantic consistency and geometric consistency, fusing the encoding tensors of the image 2D target box and the point cloud 3D target box to obtain a fused feature tensor;
inputting the fused feature tensor into a channel attention encoding-based convolutional neural network structure to finally obtain a fusion confidence score; and
redistributing the fusion confidence score to the point cloud 3D target box, and using a non-maximum suppression (NMS) algorithm to filter out redundant and falsely detected target boxes to generate the final 3D vehicle target detection result.

2. The method according to claim 1, wherein detecting the image data based on a preset image target detector to generate an image 2D target box specifically comprises:
constructing an image target detector based on a CascadeRCNN algorithm;
training the image target detector based on a preset training data set; and
inputting the image into the trained image target detector for detection to generate an image 2D target box.

3. The method according to claim 2, wherein detecting the fused point cloud data based on a preset 3D vehicle target detection model to generate a point cloud 3D target box specifically comprises:
constructing a 3D vehicle target detection model based on an improved PointPillars network model;
training the 3D vehicle target detection model based on the KITTI data set to obtain a trained 3D vehicle target detection model; and
inputting the fused point cloud data into the trained 3D vehicle target detection model to generate a point cloud 3D target box.

4. The method according to claim 3, wherein constructing a 3D vehicle target detection model based on an improved PointPillars network model specifically comprises:
improving the PointPillars network model, adding a point cloud local attention mechanism module to a pillar feature net of a traditional PointPillars network model for capturing complex features within a specific area of the inputted point cloud, and integrating an SE attention mechanism module into a 2D pseudo-image network of the traditional PointPillars network model for enhancing the ability of the network to obtain global features and information; and
constructing a three-dimensional vehicle target detection model based on the improved PointPillars network model.
